(19) United States
(12) Patent Application Publication
(10) Pub. No.: US 2026/0146979 A1
(43) Pub. Date: May 28, 2026

(54) DETECTORS

(71) Applicant: Waters Technologies Corporation, Milford, MA (US)

(72) Inventors: Jinchuan Yang, Hopkinton, MA (US); Paul Rainville, Princeton, MA (US); Jennifer Simeone, Shrewsbury, MA (US); Robert E. Birdsall, Westborough, MA (US); Duanduan Han, Hopkinton, MA (US); Joseph A. Jarrell, Newton Highlands, MA (US)

(21) Appl. No.: 19/401,749

(22) Filed: Nov. 26, 2025

Related U.S. Application Data
(60) Provisional application No. 63/725,217, filed on Nov. 26, 2024.

(51) Int. Cl. G01N 30/84; G01N 30/02; G01N 30/72; G01N 30/86

(52) U.S. Cl. CPC G01N 30/84; G01N 30/7233; G01N 30/8631; G01N 30/8665; G01N 2030/027; G01N 2030/8458

(57) ABSTRACT

Embodiments described herein relate to improved devices and techniques for improving the calibration of laboratory analytical instruments, especially those whose detector response generally exhibit a non-linear response curve. Some embodiments relate to applying a relatively high voltage at the central pin of a charged aerosol detector's (CAD's) ion trap. By applying a high voltage, relatively more small particles (which generally constitute background reagents) are driven into the ion trap's outer wall, thus improving the CAD's signal-to-noise ratio. Other embodiments, which may be used separately or together with the increased voltage, use calibration standards data and the best-fitting model from a variety of fitting models (which are not limited to a power law function) to transform the raw non-linear data points to linear data points. Consequently, a best linear fit calibration line can be obtained for each individual analyte using the transformation model most appropriate to that analyte.

### CROSS-REFERENCE TO RELATED APPLICATIONS

This application claims priority to U.S. Provisional Patent Application Ser. No. 63/725,217, entitled “IMPROVED DETECTORS” and filed on Nov. 26, 2024. The contents of the aforementioned application are incorporated herein by reference.

### BACKGROUND

A Charged Aerosol Detector (CAD) is a device that may be used in chromatography. In this respect, it is similar to an Evaporative Light Scattering Detector (ELSD) and a Condensation Nucleation Evaporation Light Scattering Detector (CNLSD).

All three detectors start by nebulizing a liquid eluent stream from a liquid chromatograph into a gas-borne stream of tiny droplets. These droplets are desolvated. If an analyte is present, this results in a stream of tiny particles (an aerosol). The size of these particles increases as the concentration of an analyte in the eluent stream increases.

In a CAD, the flowing stream of dried particles is charged by mixing it with a stream of ionized nitrogen and/or water molecules. Charge transfers from the nitrogen/water molecules to the particles of dried analyte. Larger analyte particles absorb a higher charge than smaller ones. The charged analyte particles are then collected on an electrode which is connected to a sensitive electrometer. The response of the electrometer, when graphed, typically shows one or more peaks that describe the concentrations of different particles present in the analyte. Several issues can arise in analyzing the CAD response.

First, some of the charged nitrogen or water molecules used to charge the analyte stream may remain in the stream as it is processed. This causes a detector response corresponding to the (background) nitrogen or water reagent that is not related to the signal generated by the analyte itself. This background data represents noise than can crowd out the reagent signal.

Second, the CAD response is typically non-linear to the mass of the analytes. Its relationship is therefore approximated by a power function:

Response=a(m)^{b}

Procedures have been provided by CAD manufacturers or proposed by users to transform or “linearize” the CAD response to make it appears linear to the analyte's mass. The “linearization” process involves an application of a power function to the CAD response with an exponent, so that the transformed CAD response is linear to the analyte mass:

$$Response = {( {am}^{b} )}^{PVF} = {{a}^{′} ( m )}^{1}$$

The procedure recommended by CAD manufacturers to find the optimal PFV can be tedious and error-prone. The process involves collecting CAD data for a series calibration standards with a selection of PFVs, then processing the CAD chromatographic data to determine the best PFV that gives a linear relationship between the CAD response and analyte concentration.

Alternatively, one can collect the CAD data set for a series of calibration standards with a single default PFV (e.g., 1), and calculate the CAD response at different PFVs by transforming the default CAD response by an equation:

$$CAD Signal ( simulated ) = \frac{Default {Signal}^{PVF}}{{500}^{PVF - 1}}$$

where the denominator (500\hat{ }(PFV−1)) is a normalization constant to ensure the signal is not out of the full scale of the detector.

Then the data are processed and evaluated in a similar way as discussed above to find the optimal PFV. After obtaining the optimal PFV, the linearity is verified by actual CAD data of a series calibration standards collected with the optimal PFV.

This procedure is a trial-and-error approach. A systematic approach has been proposed, which includes a detailed investigation of the variability (or relative standard deviation, RSD) of the response factor (peak area/concentration) at different PFVs, and a detailed evaluation of the response factor slope as a function of concentration. The optimal PFV is when the RSD is the smallest and the slope is closest to zero.

These procedures have several drawbacks. Firstly, they are time consuming and require additional experiments. They involves collection of data multiple times (each time involves injections of a series of standard solutions). This increases the analysis time and the workload. Secondly, The CAD transformation (or “linearization”) is limited to the power function, which may not always be the best-fitting model for the CAD response vs concentration relationship. And thirdly, there is only one optimal PFV selected for the analysis. When there are multiple analytes in the analysis, the single optimal PFV may not be suitable for all analytes.

### BRIEF SUMMARY

Exemplary embodiments relate to methods, mediums, and systems for calibrating laboratory analytical instruments such as charged aerosol detectors, liquid chromatographs, and evaporative light scattering detectors, among other. Several techniques are discussed, which may be used separately or in combination.

For example, a first technique pertaining to charged aerosol detectors (CAD) reduces the signal-to-noise ratio (SNR) of the detector response by applying a higher-than-normal potential at the ion trap of the CAD. More specifically, a charged aerosol detector (CAD) apparatus may be configured to process an analyte stream. The CAD may include an ion trap (also sometimes referred to as an ion trap central pin) configured to remove charged particles from an analysis stream by applying a voltage of 100 Volts (V) or more (e.g., 200-650 V), and a detector configured to register analyte from the analyte stream after it passes through the ion trap to generate a detector response.

In some embodiments, the voltage may be adjustable via a user interface. The user interface may offer a binary option, such as operating the ion trap at a default setting that is less than 100 V and a second selection that is 100 V or more (e.g., 200 V-650 V). In some embodiments, the user interface may present options to allow a user to select between the default option and two or more substantially greater predetermined voltages (e.g., 200 V, 400 V, or 600 V). If the user is running a chromatographic gradient separation, the voltage could be programmed to be a function of the gradient.

In some embodiments, the voltage may be adjusted depending on the detector response results. For example, the ion trap may initially be configured to apply the voltage of 100 V or more with the ion trap. Then, an amount of analyte lost to the ion trap may be determined and compared to a predetermined threshold value. If the amount of lost analyte exceeds the predetermined threshold value, the voltage applied by the ion trap may be reduced (e.g., back to a default value, or back to a predetermined value that is less than the voltage initially applied).

In some embodiments, the goal of applying a higher voltage at the ion trap may be to drive relatively small particles into a wall of the ion trap, so they are not registered at the detector alongside relatively large particles of interest. For example, the CAD may process particles having diameters greater than 9 nm and 9 nm or less, and the voltage may be selected to drive proportionally more particles having a diameter of 9 nm or less into a wall of the ion trap to remove them from the analyte stream. In some embodiments, a predetermined target signal-to-noise ratio may be defined (where relatively smaller particles, such as those having a diameter of 9 nm or less, may contribute more to the noise whereas relatively larger particles, such as those having a diameter greater than 9 nm may contribute more to the signal), and the voltage applied by the ion trap may be set to achieve the target signal-to-noise ratio.

In some embodiments, the detector response may be analyzed to produce an analyte-response curve. A log-log linear fit may be applied to the analyte-response curve to produce a fit curve that corresponds to the analyte-response curve.

Another technique may be applied to laboratory analytical instruments in general (such instruments may include a CAD, but may also include instruments such as mass spectrometers and evaporative light scattering detectors). When applied to a CAD, the below procedure may be used with or without the improvements to the ion trap discussed above.

In one aspect, such a method includes operating a laboratory analytical instrument on an analyte at a plurality of different concentrations to generate response data including a plurality of data points, assigning a first non-linear relationship to the response data. The plurality of data points in the response data may be transformed into a set of calculated response data points by applying a transformation function that is an inverse of the assigned non-linear relationship. A second linear relationship may be assigned to the calculated response data points. Constants for the transformation function may be identified that cause the second linear relationship to best approximate the calculated response data points to obtain a linear relationship between peak response parameters and the plurality of different concentrations. The transformation function with the identified constants and the calibration constants for the second linear relationship may be applied as the calibration parameters (or a set of calibration parameters) for the laboratory analytical instrument.

Among other possibilities, the laboratory analytical instrument may be one or more of a charged aerosol detector, a mass spectrometer, or an evaporative light scattering detector.

The first non-linear relationship may be a power function or second-order polynomial.

Identifying the constants may include evaluating a square of correlation coefficient (r²) value and a residual plot of a fitted line generated by the second linear relationship against the calculated response data points. A plurality of different transformation functions may be evaluated by comparing the resulting fitted linear results from the plurality of different transformation functions against each other.

The calibration parameters may be specific to the analyte, and different calibration parameters are determined for different analytes.

The peak response parameter may be a peak area.

As noted above, the first and second techniques may be applied together when the laboratory analytical instrument is a charged aerosol detector (CAD). In one example, a method may include operating a charged aerosol detector (CAD) on an analyte at a plurality of different concentrations to generate response data including a plurality of data points, where the CAD includes an ion trap configured to remove charged particles from an analysis stream containing the analyte by applying a voltage of 100 Volts (V) or more. A first non-linear relationship may be assigned to the response data. The plurality of data points in the response data may be transformed into a set of calculated response data points by applying a transformation function that is an inverse of the assigned non-linear relationship. A second linear relationship may be applied to the calculated response data points. Constants for the transformation function may be identified that cause the second linear relationship to best approximate the calculated response data points to obtain a linear relationship between peak response parameters and the plurality of different concentrations. The transformation function with the identified constants and the constants for the second linear relationship may be applied as calibration parameters (or a set of calibration parameters) for the laboratory analytical instrument.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A depicts an example of a charged aerosol detector.

FIG. 1B depicts the ion trap of the charged aerosol detector in accordance with one embodiment.

FIG. 2 illustrates an example of a mass spectrometry system according to an exemplary embodiment.

FIG. 3 depicts an amount of background noise present in an analyte analysis at different ion trap voltages in accordance with one embodiment.

FIG. 4 depicts the R² value calculated for data generated with an ion trap at different voltages in accordance with one embodiment.

FIG. 5A shows a detector response for a CAD analysis of four sugars in accordance with one embodiment.

FIG. 5B shows the peak area for each sugar when the ion trap is operated at 20 V in accordance with one embodiment.

FIG. 5C shows the peak area for each sugar when the ion trap is operated at 650 V in accordance with one embodiment.

FIG. 6 shows the difference in signal-to-noise ratio for response data generated by an ion trap operated at two different voltages in accordance with one embodiment.

FIG. 7 is a flow chart describing an exemplary method for configuring an ion trap according to an embodiment described herein.

FIG. 8 depicts the linearization of data in accordance with one embodiment.

FIG. 9A depicts CAD data for an analyte at multiple different concentrations in accordance with one embodiment.

FIG. 9B depicts a first non-linear relationship applied to the data of FIG. 9A in accordance with one embodiment.

FIG. 9C depicts reconstructed data after applying an inverse of the first-non-linear relationship shown in FIG. 9B to the data shown in FIG. 9A in accordance with one embodiment.

FIG. 9D depicts a second linear relationship applied to the data of FIG. 9C in accordance with one embodiment.

FIG. 10 illustrates a linearization process 1000 in accordance with one embodiment.

FIG. 11 depicts an illustrative computer system architecture that may be used to practice exemplary embodiments described herein.

### DETAILED DESCRIPTION

Exemplary embodiments provide techniques for improving the calibration of laboratory analytical instruments, including charged aerosol detectors (CADs), mass spectrometers, and evaporative light scattering detectors.

One technique involves operating an ion trap of a CAD at a voltage that is significantly greater than its standard or default setting (which is typically about 20 V, while the main body is held at electrical ground). At substantially higher voltages, such as 600 V or 650 V, a significantly greater number of particles having a smaller diameter (e.g., equal to or less than 9 nm) are driven into the wall of the ion trap. Because the particles of interest tend to be larger, this can improve the signal-to-noise ratio of the detector of the CAD.

Another technique involves determining calibration parameters through curve-fitting different non-linear responses to reconstructed data. In this method, detector response data for an analyte at different concentrations can be generated in a single experimental run. A first non-linear relationship is determined for the data, and its inverse function is applied to reconstruct the linearized data. The reconstructed data is then subjected to a second linear relationship, and the constants for the inverse function (or the transformation function) are optimized. The transformation function and its constants can be used as a calibration setting applied to the output signal of the detector in order to linearize the output data more efficiently and more accurately.

Various combinations of these improvements are also possible and contemplated. It is specifically contemplated that the ion trap of a CAD may be operated at higher voltage without applying the curve-fitting features of the second technique. This can have a number of advantages, such as a lower signal-to-noise ratio, improved detection limits, and improved calibration through the reduction of the effect of varying mobile phase impurities, among others.

It is also specifically contemplated that the improved curve-fitting technique may be used without applying a higher voltage to the ion trap. This reduces the number of injections needed for calibration, provides more accurate results through the use of additional transformation models and/or the use of different transformation models for different analytes, can be used with additional types of detectors, and provides a better characterization of chromatography parameters such as resolution, efficiency, signal-to-noise ratio, and moments of distribution.

It is also specifically contemplated that the two approaches may be used together to achieve the effects noted above, as well as additional synergies. For example, reducing the background noise using the high-voltage technique can allow the transformations applied in the second technique to achieve even better fits.

### EXEMPLARY EMBODIMENTS

As an aid to understanding, a series of examples will first be presented before detailed descriptions of the underlying implementations are described. It is noted that these examples are intended to be illustrative only and that the present invention is not limited to the embodiments shown.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

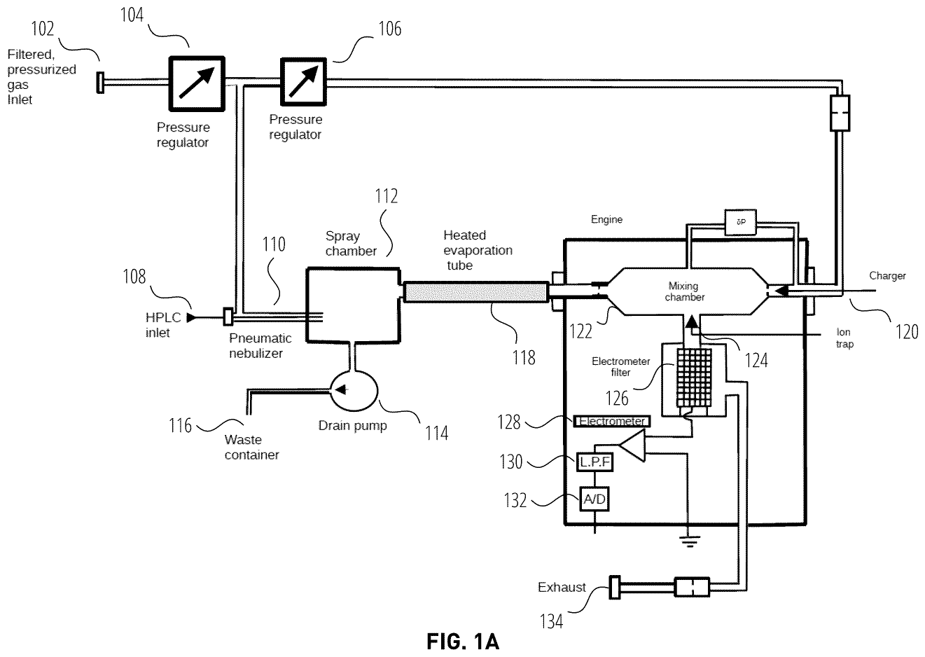

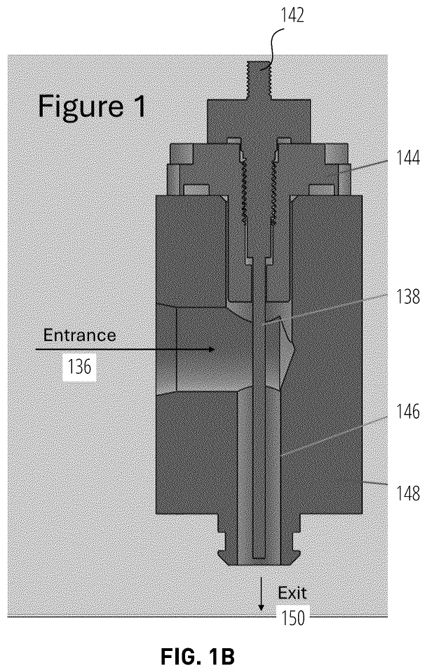

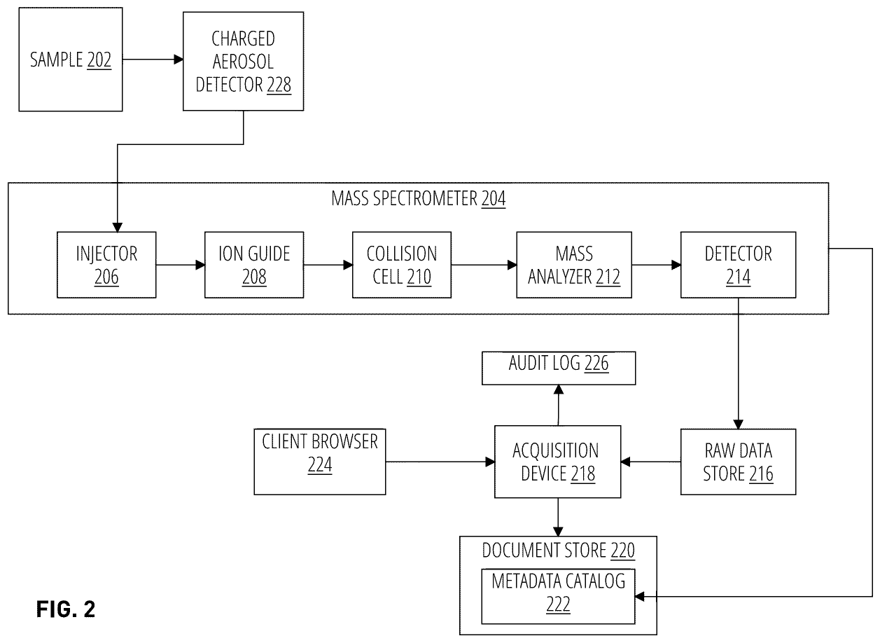

FIG. 1A depicts an example of a charged aerosol detector (CAD). In general, Charged Aerosol Detectors function by nebulizing an analyte stream, typically the output of a chromatographic separation (See FIG. 2). The resulting droplets have a distribution of sizes. The droplets are evaporated. If a non-volatile or semi-volatile analyte is present, this results in a size distribution of dried particles. The size of these particles increases with increasing analyte concentration. These particles are then charged by mixing them with a stream of charged reagent nitrogen and/or water molecules. Charge is transferred to the particles in this mixing process. Excess charged reagent ions are removed by passing the flow of charged particles and excess reagent ions into the entrance of what is an ion trap.

More specifically, a gas inlet 102 receives filtered, pressurized gas (such as nitrogen gas) that acts as a carrier for the analyte. The gas may be received, for example, a pressure of 40-80 psi. The gas may be provided to a pressure regulator 104 that keeps the gas at a target pressure.

The filtered, pressurized gas then passes to a T-junction that directs some of the filtered, pressurized gas to a pneumatic nebulizer 110 where it is combined with the analyte. The analyte entering pneumatic nebulizer 110 may be received in a liquid stream from a high performance liquid chromatography (HPLC) inlet 108.

The pneumatic nebulizer 110 nebulizes the liquid stream, thereby converting it into a gas-borne stream of tiny droplets. The aerosol is sprayed into a spray chamber 112, which optionally may be designed to condition the aerosol to remove relatively large droplets (e.g., droplets larger than a predetermined size). The large droplets naturally drop towards a drain at the bottom of the spray chamber 112, where a drain pump 114 carries them to a waste container 116.

The droplets then are carried to a heated evaporation tube 118 where solvent is evaporated from the droplets to leave dried particles. Thus a higher concentration of analyte in the liquid stream from HPLC inlet 108 introduced into pneumatic nebulizer 110 will produce an aerosol of dried particles with larger average diameters. The dried particles are then provided to one entrance to a mixing chamber 122.

Meanwhile, some of the filtered, pressurized gas from the gas inlet 102 exits the T-junction towards another pressure regulator 106. The regulated gas is then provided to a charger 120. The charger 120 adds a charge to the filtered, pressurized gas molecules, typically nitrogen although water molecules are also charged if present, such as by forming an ion jet via corona discharge. The resulting charged particles are then provided to another entrance to the mixing chamber 122.

In the mixing chamber, the dried particles are mixed with the charged particles so that the charge from the charged particles is substantially transferred to the dried particles. Here, larger analyte particles absorb a higher charge than smaller particles, which allows the concentration of the analyte to be determined by measuring the particle charges. An ion trap 124 is used to remove the excess nitrogen or water particles (see FIG. 1B). The remaining charged particles are then collected by an electrode such as an electrically conductive filter 126 that allows gas to pass through while substantially capturing the charged particles. The collection of these charged dried analyte particles is registered by a sensitive electrometer 128. Since a higher analyte concentration produces large diameter particles and large particles carry more charge after the mixing chamber, the current measured by electrometer 128 is also a measure of analyte concentration To support this determination, the CAD may make use of electronics such as a low pass filter 130 and an analog/digital converter 132. Any remaining gas is exhausted from the CAD through the exhaust 134.

FIG. 1B shows the ion trap 124 in more detail.

Particles may enter the ion trap 124 through the entrance 136. Voltage is applied to an ion trap central pin 138 via a voltage input 140 that is insulated from the main body 148 of the ion trap 124 by an insulator 144.

Normally a positive potential of about 20 Volts is applied to the ion trap central pin 138 while the main body 148 is held at electrical ground. This establishes an internal electric field that is sufficient to drive almost all of the lighter nitrogen and water ions to the outer wall 146. The charged particles, being orders of magnitude heavier, are substantially unaffected by the electric field and exit the ion trap at the exit 150 where they are then collected on a surface. The electrical current thus generated is measured and thus becomes a measure of analyte concentration.

Exemplary embodiments described herein may also be used with other types of sensors, including mass spectrometry (MS) detectors, liquid chromatography (LC) detectors, LCMS detectors, and evaporative light scattering detectors (ELSDs). For purposes of illustration, FIG. 2 is a schematic diagram of a system that may be used in connection with techniques herein. Although FIG. 2 depicts particular types of devices in a specific MS configuration, one of ordinary skill in the art will understand that different types of chromatographic devices (e.g., LCMS, MS, tandem MS, etc.) may also be used in connection with the present disclosure.

A sample 202 is injected into a charged aerosol detector 228 through the gas inlet 102. The output from the charged aerosol detector 228 may be input to a mass spectrometer 204 for analysis. For example, the output from the charged aerosol detector 228 may be collected on a collector or output by an exhaust for further analysis.

Optionally, in a non-destructive CAD device, at the mass spectrometer 204 the sample may be initially desolved and ionized by a desolvation/ionization device 114. Desolvation can be any technique for desolvation, including, for example, a heater, a gas, a heater in combination with a gas or other desolvation technique. Ionization can be by any ionization techniques, including for example, electrospray ionization (ESI), atmospheric pressure chemical ionization (APCI), matrix assisted laser desorption (MALDI) or other ionization technique. Ions resulting from the ionization are fed to a collision cell 210 by a voltage gradient being applied to an ion guide 208. Collision cell 210 can be used to pass the ions (low-energy) or to fragment the ions (high-energy).

Different techniques (including one described in U.S. Pat. No. 6,717,130, to Bateman et al., which is incorporated by reference herein) may be used in which an alternating voltage can be applied across the collision cell 210 to cause fragmentation. Spectra are collected for the precursors at low-energy (no collisions) and fragments at high-energy (results of collisions).

The output of collision cell 210 is input to a mass analyzer 212. Mass analyzer 212 can be any mass analyzer, including quadrupole, time-of-flight (TOF), ion trap, magnetic sector mass analyzers as well as combinations thereof. A detector 214 detects ions emanating from mass analyzer 122. Detector 214 can be integral with mass analyzer 212. For example, in the case of a TOF mass analyzer, detector 214 can be a microchannel plate detector that counts intensity of ions, i.e., counts numbers of ions impinging it.

A raw data store 216 may provide permanent storage for storing the ion counts for analysis. For example, raw data store 216 can be an internal or external computer data storage device such as a disk, flash-based storage, and the like. An acquisition 218 analyzes the stored data. Data can also be analyzed in real time without requiring storage in a storage medium 124. In real time analysis, detector 214 passes data to be analyzed directly to computer 126 without first storing it to permanent storage.

Collision cell 210 performs fragmentation of the precursor ions. Fragmentation can be used to determine the primary sequence of a peptide and subsequently lead to the identity of the originating protein. Collision cell 210 includes a gas such as helium, argon, nitrogen, air, or methane. When a charged precursor interacts with gas atoms, the resulting collisions can fragment the precursor by breaking it up into resulting fragment ions. Such fragmentation can be accomplished as using techniques described in Bateman by switching the voltage in a collision cell between a low voltage state (e.g., low energy, <5 V) which obtains MS spectra of the peptide precursor, with a high voltage state (e.g., high or elevated energy, >15V) which obtains MS spectra of the collisionally induced fragments of the precursors. High and low voltage may be referred to as high and low energy, since a high or low voltage respectively is used to impart kinetic energy to an ion.

Various protocols can be used to determine when and how to switch the voltage for such an MS/MS acquisition. For example, conventional methods trigger the voltage in either a targeted or data dependent mode (data-dependent analysis, DDA). These methods also include a coupled, gas-phase isolation (or pre-selection) of the targeted precursor. The low-energy spectra are obtained and examined by the software in real-time. When a desired mass reaches a specified intensity value in the low-energy spectrum, the voltage in the collision cell is switched to the high-energy state. The high-energy spectra are then obtained for the pre-selected precursor ion. These spectra contain fragments of the precursor peptide seen at low energy. After sufficient high-energy spectra are collected, the data acquisition reverts to low-energy in a continued search for precursor masses of suitable intensities for high-energy collisional analysis.

Different suitable methods may be used with a system as described herein to obtain ion information such as for precursor and product ions in connection with mass spectrometry for an analyzed sample. Although conventional switching techniques can be employed, embodiments may also use techniques described in Bateman which may be characterized as a fragmentation protocol in which the voltage is switched in a simple alternating cycle. This switching is done at a high enough frequency so that multiple high- and multiple low-energy spectra are contained within a single chromatographic peak. Unlike conventional switching protocols, the cycle is independent of the content of the data. Such switching techniques described in Bateman, provide for effectively simultaneous mass analysis of both precursor and product ions. In Bateman, using a high- and low-energy switching protocol may be applied as part of an LC/MS analysis of a single injection of a peptide mixture. In data acquired from the single injection or experimental run, the low-energy spectra contains ions primarily from unfragmented precursors, while the high-energy spectra contain ions primarily from fragmented precursors. For example, a portion of a precursor ion may be fragmented to form product ions, and the precursor and product ions are substantially simultaneously analyzed, either at the same time or, for example, in rapid succession through application of rapidly switching or alternating voltage to a collision cell of an MS module between a low voltage (e.g., generate primarily precursors) and a high or elevated voltage (e.g. generate primarily fragments) to regulate fragmentation. Operation of the MS in accordance with the foregoing techniques of Bateman by rapid succession of alternating between high (or elevated) and low energy may also be referred to herein as the Bateman technique and the high-low protocol.

The data acquired by the high-low protocol allows for the accurate determination of the retention times, mass-to-charge ratios, and intensities of all ions collected in both low- and high-energy modes. In general, different ions are seen in the two different modes, and the spectra acquired in each mode may then be further analyzed separately or in combination. The ions from a common precursor as seen in one or both modes will share the same retention times (and thus have substantially the same scan times) and peak shapes. The high-low protocol allows the meaningful comparison of different characteristics of the ions within a single mode and between modes. This comparison can then be used to group ions seen in both low-energy and high-energy spectra.

In summary, such as when operating the system using the Bateman technique, a sample 202 is injected into the LC/MS system. The LC/MS system produces two sets of spectra, a set of low-energy spectra and a set of high-energy spectra. The set of low-energy spectra contain primarily ions associated with precursors. The set of high-energy spectra contain primarily ions associated with fragments. These spectra are stored in a raw data store 216. After data acquisition, these spectra can be extracted from the raw data store 216 and displayed and processed by post-acquisition algorithms in the acquisition 218.

Metadata describing various parameters related to data acquisition may be generated alongside the raw data. This information may include a configuration of the mass spectrometer 204 (or other chromatography apparatus that acquires the data), which may define a data type. An identifier (e.g., a key) for a codec that is configured to decode the data may also be stored as part of the metadata and/or with the raw data. The metadata may be stored in a metadata catalog 222 in a document store 220.

The acquisition 218 may operate according to a workflow, providing visualizations of data to an analyst at each of the workflow steps and allowing the analyst to generate output data by performing processing specific to the workflow step. The workflow may be generated and retrieved via a client browser 224. As the acquisition 218 performs the steps of the workflow, it may read raw data from a stream of data located in the raw data store 216. As the acquisition 218 performs the steps of the workflow, it may generate processed data that is stored in a metadata catalog 222 in a document store 220; alternatively or in addition, the processed data may be stored in a different location specified by a user of the acquisition 218. It may also generate audit records that may be stored in an audit log 226.

The exemplary embodiments described herein may be performed at the client browser 224 and acquisition device 218, among other locations.

### Improving Calibration Curve-Fitting by Applying a Higher Potential by the Ion Trap

As discussed above, a charged aerosol detector charges incoming particles of an analyte stream by mixing them with charged reagent molecules, such as nitrogen or water molecules. Charge is transferred to the particles of the analyte stream through this mixing process. Some of the remaining charged nitrogen and water molecules are then removed in an ion trap.

During the mixing process, it is generally believed that the amount of charge that is transferred to the dry particles of the analyte stream is proportional to d^{1.133}, where d is the particle diameter, for particles ranging from 10 nm to 1.0 um in diameter. The amount of charge transferred to particles smaller than 9 nm in diameter, however, is believed to be proportional to d^{2.25}.

This produces an analyte-response curve that has two very different curvature profiles depending on the analyte concentration. Analysts may apply a curve fitting algorithm to mathematically model the response of the CAD. A curve fitting algorithm attempts to fit a curve defined by a mathematical formula or equation to the data by adjusting parameters (e.g., constants) of the formula while achieving the best fit possible. Fit may be measured, for example, by a regression analysis such as a least-squares regression or a residual analysis.

One commonly used curve fitting algorithm used with CADs is a log-log linear fit (sometimes just called log-log). A log-log linear fit calculates the best straight line that fits a plot of the log of the detector response against the log of the concentration injected. So for example, if y is the response, x is the mass injected and y=ax^{m}, then the slope of the best fit straight line will be m.

Because the response of a CAD follows two different power laws, however, the range over which a log-log linear fit can provide a suitable fit is limited.

The present inventors have noted that residual impurities in the chromatographic mobile phases primarily contribute particles of relatively small size (e.g., 9 nm or less), while the analyte stream including particles of interest tends to contribute particles of relatively large size (e.g., greater than 9 nm). Thus, if more of these smaller particles resulting from the residual mobile phase impurities can be removed from the stream, the amount of background noise can be reduced and the remaining particles will generally follow a single curvature profile. Thus, the log-log linear fit can provide a better model of the curvature of the CAD response data.

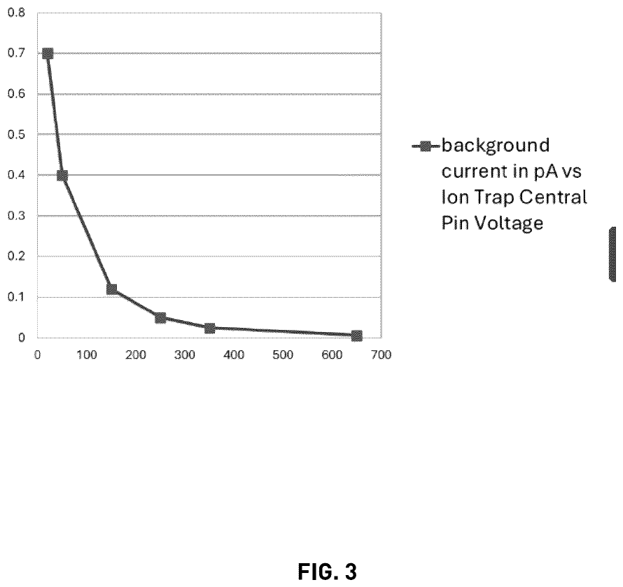

The present inventors have discovered that the fit provided by a log-log linear algorithm can be improved by applying a higher potential (as high as +650 Volts) on the ion trap central pin 138. With these applied potentials, a substantial portion of the smaller charged particles are driven to the ion trap outer wall 146. A lesser fraction of larger particles may also be driven to the outer wall 146. This lowers the background current as shown in FIG. 3 and reduces the non-linearity of the response curve.

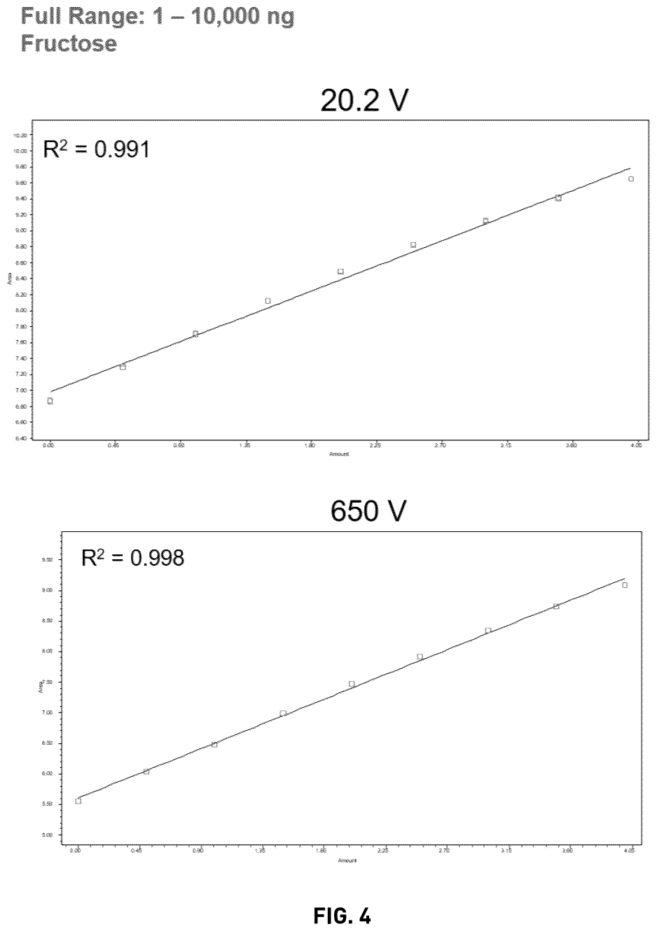

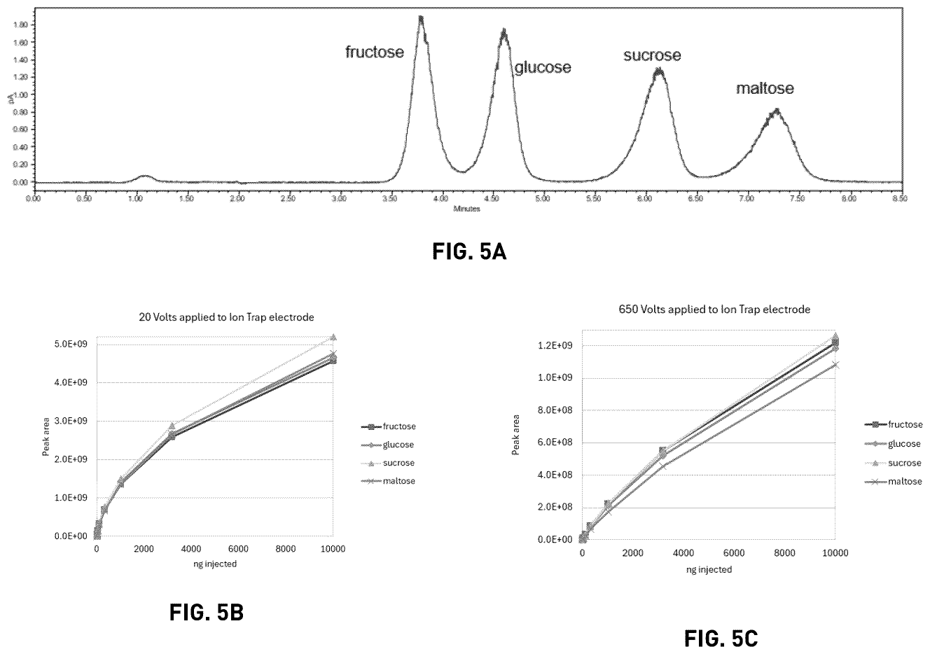

The reduced non-linearity makes it possible to achieve lower residuals than are achievable in the standard configuration with +20 Volts applied to the central pin. This occurs because, as discussed above, the smallest particles contribute greater non-linearity than larger particles. Examples of this improvement are illustrated in FIG. 4 and FIG. 5A-FIG. 5C.

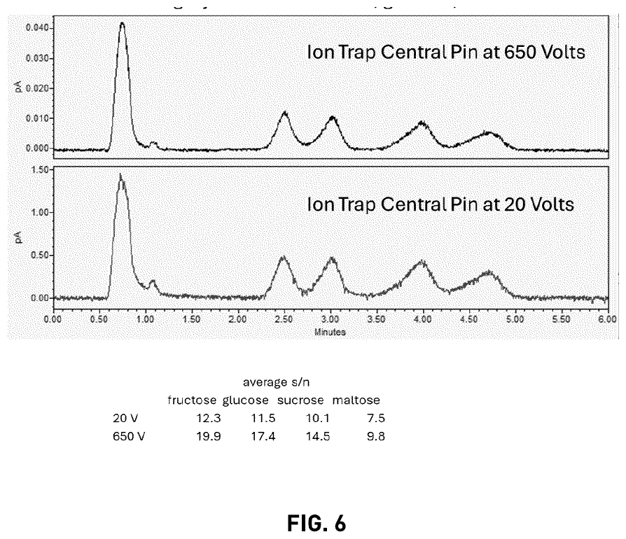

Similarly, in some applications, limits of detection may be improved (even if the magnitude of the total signal has decreased through the loss of some of the larger particles to the outer wall 146). This is illustrated in FIG. 6, which shows the chromatograms produced from 0.316 ng each of four sugars (fructose, glucose, sucrose and mannose). The lower chromatogram was acquired with the conventional +20 Volts applied to the ion trap central pin 138. The upper chromatogram was acquired with +650 Volts applied to the ion trap central pin 138.

It is evident that the signal-to-noise of the peaks in the upper chromatogram is better. This is presumably because it is the noise in the background level that determines limits of detection and the application of the higher potential reduces that noise more than the amplitude of the peaks since the noise arises substantially from the smaller particles.

Another problem in non-linear universal detectors is that any calibration is sensitive to a change in the background signal level. i.e. the change in response for two similar injections of the same sample will be different depending on the amplitude of the baseline. Commonly used mobile phases such as acetonitrile will typically have background non-volatile impurity levels of 0.5 to 1.0 ppm, but these will vary from one bottle to the next. Applying a higher potential to the ion trap central pin 138 also reduces the effect of varying mobile phase impurities since the impurities produce a larger share of smaller particles.

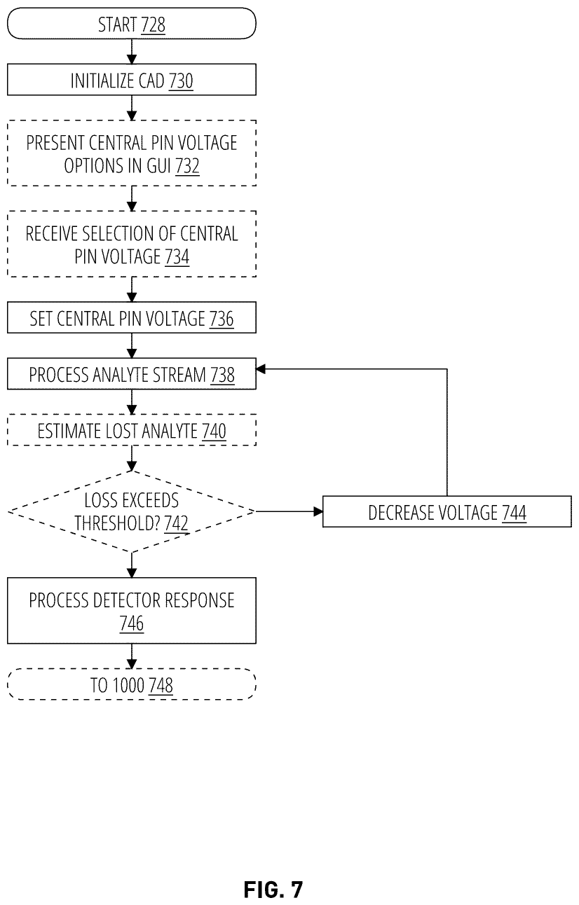

FIG. 7 illustrates an example routine for applying a relatively high voltage at the ion trap central pin 138, as discussed above. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes starting at start block 728.

According to some examples, the method includes initializing CAD at block 730. For instance, the CAD may be powered on and set to a calibration mode. One or more calibrating analytes may be provided/input to the CAD for analysis. A graphical user interface (GUI) for setting configuration options for the CAD may be displayed on a display of a control computer.

According to some examples, the method includes presenting central pin voltage options in the control computer GUI at block 732. In some embodiments, a user may be presented with a binary option (e.g., to run the CAD with the central pin voltage set to a normal, default value, such as about 20 V, or to run the CAD with the central pin voltage set to a substantially higher voltage, such as 100 V or greater, in some embodiments 200 V or greater). In some embodiments, the user may be permitted to set the central pin voltage, up to a maximum value defined by the limits of the CAD or central pin. In some embodiments, the user may be presented with multiple predetermined options (e.g., a default option of about 20 V, a second option of about 100 V, a third option of about 200 V, a fourth option of about 400 V, and a fifth option of about 600V; the specific values of the options may vary depending on the application).

According to some examples, the method optionally includes receiving a selection of a central pin voltage through the GUI at block 734. The control computer may register a user's selection of a graphical element corresponding to the selected voltage.

Whether or not the user was permitted to select a voltage at block 734, according to some examples, the method includes setting central pin voltage at block 736. If the user selected a voltage, the CAD may be configured to apply the selected voltage at the central pin. For instance, the control computer may generate a command signal configured to cause the CAD to use the selected voltage as the voltage at the voltage input 142 of the ion trap central pin 138 and may transmit the command signal to the CAD. If the user did not select a voltage, the control computer may generate a command signal setting the voltage to a predetermined high voltage (e.g., greater than 100 V), or the CAD may default to applying the high voltage when initialized at block 730. The voltage may be set based on an estimate of the amount of reagents and/or analyte that will be diverted into the outer wall 146; for example, a target signal-to-noise ratio or an acceptable amount of lost analyte may be defined, and a voltage estimated to achieve the defined target may be selected. The estimate may be based on modeling, simulation, historical data, a mathematical equation or formula, etc.

According to some examples, the method includes processing the analyte stream at block 738. The CAD may operate according to its specifications to process the analyte stream, including applying the voltage set at block 736 at the ion trap central pin 138.

According to some examples, the method optionally includes estimating an amount of lost analyte at block 740. For example, the detector output may be a series of data points (e.g., as determined by the current registered on the detector, measured in amperes, as compared to the amount of elapsed time since the start of the analysis at which the current was registered) that includes one or more peaks, each peak having a peak area. A minimum expected intensity (e.g., the height of each peak) or minimum expected peak area may be defined. If the detector signal fails to meet these thresholds, then the amount of lost analyte may be estimated to be more than a threshold value. Alternatively, a target signal-to-noise ratio may be established. If too much analyte is lost (thus lowering the signal-to-noise ratio below the target), then it may be determined that too much analyte has been lost. Still further, the amount of analyte lost to the outer wall 146 of the ion trap 124 may be estimated using simulation, modeling, a mathematical formula or equation, etc.

If it is determined, at decision block 742, that more than a predetermined threshold amount of analyte has been lost, then processing may proceed to block 744 and the voltage applied at the central pin may be reduced. The voltage may be reduced by a predetermined static amount, or may be reduced by a dynamic amount that depends on the results in blocks 740-742. For example, if the amount of lost analyte exceeded the threshold by only a small amount, then the voltage may be decreased by a relatively small amount. If the amount of lost analyte exceeded the threshold by a relatively large amount, then the voltage may be reduced by a relatively large amount.

According to some examples, the method includes processing detector response at block 746. This may involve, for example, applying a log-log linear fit to the data points representing the detector response. The fit may be used as a setting for a calibration parameter; for example, future analysis data from the CAD may be transformed according to the fit determined at block 746 so as to be comparable to other data generated at other times or by other devices.

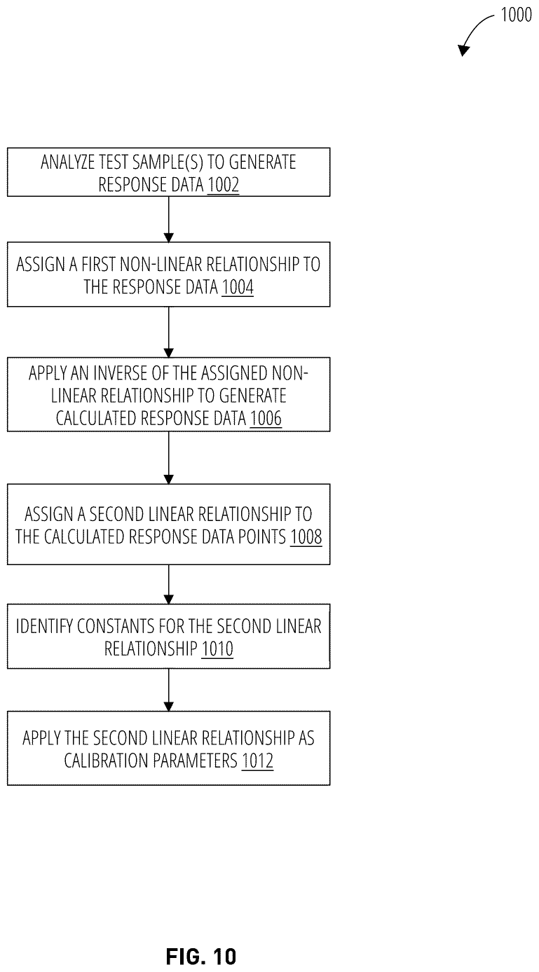

Optionally, the above-described method may be applied in conjunction with the linearization protocol discussed below. In such embodiments, processing the detector response at block 746 may involve applying the method described in connection with FIG. 10 at done block 748.

### A Linearization Protocol for Improved Curve Fitting for a Non-Linear Detection Response

A CAD response, as well as the response of other types of detectors such as MS, LCMS, ELSD, and others, is typically non-linear to the mass of the analytes. Its relationship may be approximated by a power function:

$$Response = {a ( m )}^{b} \qquad Equation 1$$

Conventionally, the detector response is linearized with respect to the analyte's mass for processing. Linearization usually involves applying a power function to the CAD response with an exponent (called a power function value, PFV) that is ideally a reciprocal of the intrinsic exponent (b above), so that the transformed CAD response is linear to the analyte mass:

$$Response = {( {am}^{b} )}^{PVF} = {{a}^{′} ( m )}^{1} \qquad Equation 2$$

$$( when PFV = 1 / b )$$

Note that the exponent b is not (necessarily) a constant, but rather may change with the analyte amount or the analyte mass m.

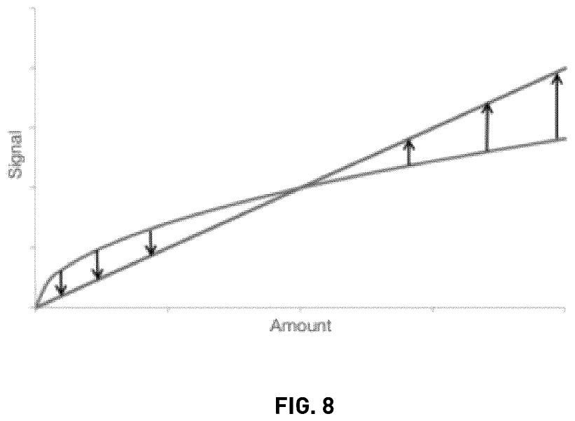

Conceptually, this approach is illustrated in FIG. 8, where the non-linear response line (which can be approximated by a power function as described in Equation 1) is converted into a linear response line by applying Equation 2 above. Assuming that the non-linear response line was the response for a calibrating standard, subsequent analyses using the laboratory analytical instrument may be transformed into a linear response by applying Equation 2 with the values determined during calibration.

The PFV is then used during data acquisition and affects the internal signal processing of the detector. The PFV adjusts the signal output of the detector and essentially sets the range over which the detector response is linear. An optimal PFV also allows for better and more accurate calculation of measures of chromatographic performance (e.g., resolution) and limits of detection. One equation for the signal output for the detector is shown below:

$$Signal Output = \frac{{( Default Signal )}^{PFV}}{{500}^{PFV - 1.}} \qquad Equation 3$$

The denominator in Equation 3 is used to normalize the output to prevent the signal from exceeding the full scale range of the detector. In this example, 500 is the instruments' full-scale current (pA).

This approach is conventionally a trial-and-error approach that involves multiple experimental runs. Because it only considers linearizing by a power function, it may not provide the best fit when the data follows a different curve model (such as a 2nd order polynomial function).

Exemplary embodiments provide a data processing protocol that uses calibration standards data (which may be gathered in a sample analysis run using a calibration standard as the sample) and the best fitting model from a variety of fitting models (not limited to a power law function) to transform the raw data points (non-linear) to linear data points, so that a best linear fit (calibration line) can be obtained for each individual analyte.

In brief summary, the protocol that involves:
1. Processing a non-linear detector's chromatographic responses of a series of calibration standards, and obtaining a non-linear relationship between the peak response (peak area, for example) and concentrations. The resulting non-linear relationship could be a power function, a 2nd order polynomial equation, or other non-linear functions. The working concentration range can also be determined from this evaluation. The working concentration range typically includes a range where the response is sensitive to the concentration change, but does not include a flat region or near-flat region where the signal becomes not sensitive to the concentration.
2. Using an inverse function of the fitted equation obtained in step (1) to transform the non-linear detector's response datapoints to calculated response datapoints. Optionally, multiple types of functions may also be used to assist in the selection of the best transformation function through comparison. For example, if a power law function and a 2nd order polynomial function are found comparable in step (1), the inverse functions of both could be used for comparison.
3. Reconstructing the chromatographic peak profile using the calculated datapoints (and their corresponding runtime).
4. Processing the reconstructed chromatographic peaks, and seeking the best constants in those equations (power law, 2nd polynomial, or other equation) by using a solver to obtain a linear relationship (e.g., by a least square regression) between peak response (peak area for example) and the analyte concentration. The tools to evaluate the linearity include square of correlation coefficient (R2) and residual plot of the fitted line.
5. (optional) Comparing the fitted linear results using various transformation models (or equations) to find the best transformation (or “linearization”) model.
6. The equation and its best fitted constants are used as (part of) the calibration parameters for the quantification of the analytes content in samples under the specific conditions. Each analyte may have its own set of calibration parameters.

This approach can be compared to a conventional approach. In the conventional approach, detector data is acquired with the output response calibrated to various PFVs (e.g., 1.0, 1.2, 1.4, etc.). This requires multiple experimental runs and/or simulations. For calibration standards in the sample queue, the chromatographic data is then processed to obtain responses (such as peak area or height) for each tested PFV. The responses are plotted against the concentrations, and the data is evaluated for response factors at various concentrations, and the standard deviations of those response factors. Each PFV is compared to find the optimal PFV that causes the data to most closely approximate a linear curve. The selected optimal PFV may be tested by acquiring new data using the PFV. The determined PFV may then be used in future analyses.

In contrast to this conventional approach, the proposed protocol only needs to perform an experimental run for a single PFV (e.g., 1.0). The chromatographic data is still processed to obtain a response, which is plotted against concentrations, but much less data is processed and plotted because only data for a single PFV is used. A transformation is then applied to the datapoints, and a solver is used to seek the best transformation parameter to achieve a linear fit. This transformation parameter is not limited to transformations applying a PFV, but may include other non-linear models such as a 2nd-order polynomial equation. Samples may then be analyzed using linearized data from the optimal transformation parameters.

The benefits of this proposed protocol include:
7. No additional injections are needed. In a typical quantification sample queue, calibration standards are included (usually bracketing the unknown samples). These standards data are used for the “linearization” process. This reduces the sample analysis time.
8. Various transformation models can be used. The protocol is not limited to applying the power function model. This allows more accurate results because another model may fit the data better than a power function.
9. Each analyte may have a different transformation model and their own parameters (equation constants). This offers more accurate results for different analytes.
10. This protocol can be applied to CADs, as well as other non-linear detectors, such as evaporative light scattering detectors (ELSD) and mass spectrometers (MS).
11. The reconstructed chromatogram (using the transformed datapoints that are linear to concentration) show peak profiles closer to the true peak profiles (the peak profiles from a linear detection, or concentration vs RT distribution), which allows a true characterization of the chromatography such as resolution, efficiency, signal to noise, and moments of distribution.

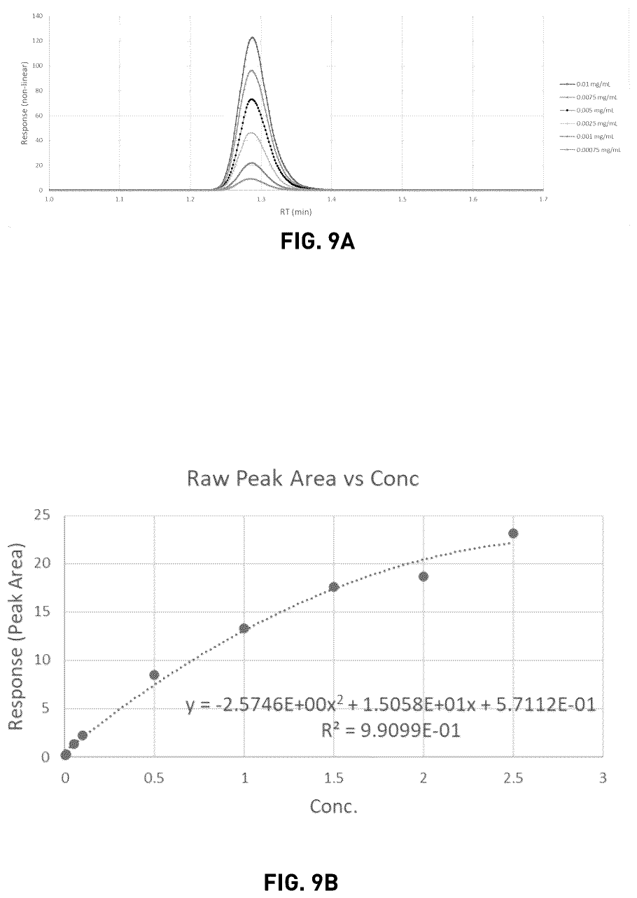

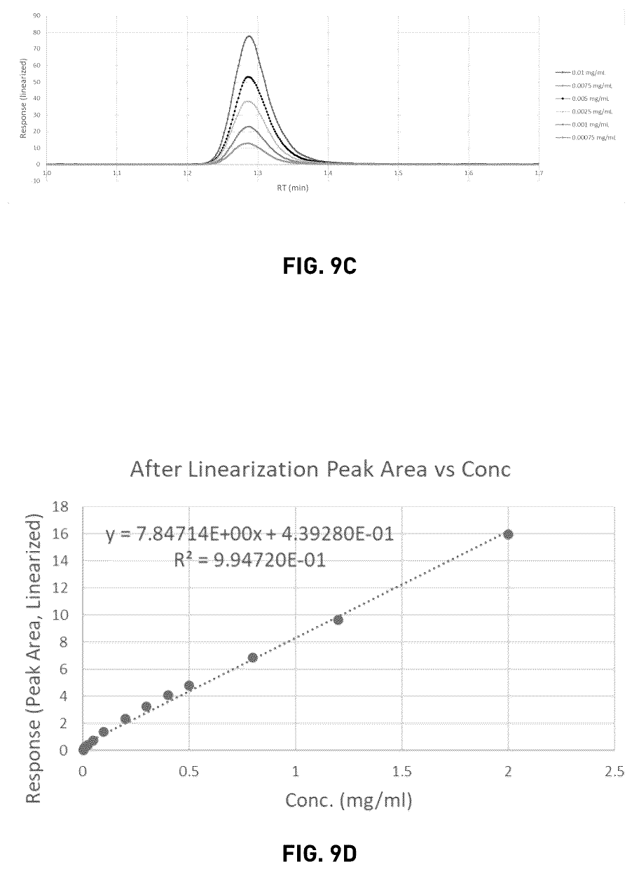

This approach is described in more detail with reference to FIG. 9A-FIG. 9D.

FIG. 9A depicts a graph of response curves for different injections of calibrant at different concentrations. This data may be acquired with multiple injections in a single experimental run of a laboratory analytical instrument having a non-linear response, such as a CAD, MS, LCMS, or ELSD. The concentrations of the calibrants is known.

FIG. 9B then shows a plot of the peak response (peak area, in this case, although other parameters such as peak height may be used) versus the known concentration for each calibrant. FIG. 9B shows a non-linear relationship (Y=f(x)) between concentration and peak response. This corresponds to Step 1 in the protocol described above. In some cases, multiple different models of non-linear relationships may be tested here (e.g., power law function, quadratic, etc.).

The inverse function (X=f⁻¹(y)), with proper modification or adjustment, may be applied to transform the non-linear signal data into a linear signal. This corresponds to Step 2 in the protocol described above. FIG. 9C shows the datapoints after transformation by the inverse function, which corresponds to Step 3 in the protocol described above.

Next, the peak response of the reconstructed chromatogram peaks from FIG. 9C are plotted against the known concentrations (FIG. 9D). This data is fit to a linear model, and the constants of the inverse function (f⁻¹(y)) are adjusted using a solver to obtain the maximum possible R² (i.e., the R² value closest to 1.0). This corresponds to Step 4 in the protocol described above. At this stage, different linearization models can be evaluated to determine the best result (i.e., the result giving the highest R² value). This corresponds to optional Step 5 in the protocol described above.

When the appropriate linearization model and constants have been identified, these values may be used as configuration or calibration parameters for the laboratory analytical instrument. Different analytes may be assessed and provided with different models and/or constants for their configuration or calibration parameters. This corresponds to Step 6 in the protocol described above.

FIG. 10 illustrates an example linearization process 1000 for a linearization process as described above. Although the example linearization process 1000 depicts a particular sequence of operations, the sequence may be altered without departing from the scope of the present disclosure. For example, some of the operations depicted may be performed in parallel or in a different sequence that does not materially affect the function of the linearization process 1000. In other examples, different components of an example device or system that implements the linearization process 1000 may perform functions at substantially the same time or in a specific sequence.

According to some examples, the method includes operating a laboratory analytical instrument on an analyte at a plurality of different concentrations to generate response data comprising a plurality of data points at block 1002. The laboratory analytical instrument may be any suitable laboratory analytical instrument having a non-linear detector response, such as a charged aerosol detector, a mass spectrometer, or an evaporative light scattering detector. The analyte may be a particular analyte injected in a single experimental run in multiple injections, each injection at a different concentration.

According to some examples, the method includes assigning a first non-linear relationship to the response data at block 1004. The first non-linear relationship may be any suitable non-linear relationship, such as a power function or second-order polynomial function. Multiple non-linear relationships may be evaluated to determine which best fits the data. For example, a library of several different models or types of non-linear relationships defined by mathematical equations having constants may be stored and accessed. One or more of the models from the library may be selected for use (either by default, or by offering the user a choice of available models in a user interface). The constants may be adjusted (e.g., using a solver program) until an evaluation parameter, such as an R² value calculated to determine the data fit, is optimized or exceeds a predetermined threshold level. In some embodiments, different types of non-linear models may be evaluated independently, each attempting to optimize the evaluation parameter by adjusting its respective constants, and the non-linear model that achieves the best evaluation parameter may be selected as the first non-linear relationship.

According to some examples, the method includes transforming the plurality of data points in the response data into a set of calculated response data points by applying an inverse of the assigned first non-linear relationship at block 1006.

According to some examples, the method includes identify constant for the transformation function at block 1010. The transformation function may be any suitable function, such as a power function or a second order polynomial function. Multiple different transformation functions may be evaluated to determine which best fits the data.

According to some examples, the method includes identifying constants for the transformation function that cause the second linear relationship to best approximate the calculated response data points to obtain a linear relationship between peak response parameters and the plurality of different concentrations at block 1010. The peak response parameters may be, for example, a peak area or a peak height. Identifying the constants may involve evaluating parameters, such as a square of correlation coefficient (R²) value and a residual plot of a fitted line generated by the second linear relationship against the calculated response data points to identify the best fit. The constants may be determined or adjusted by a solver program. As was the case for the first non-linear response, multiple different types of transformation functions may be evaluated, and the type of transformation function that yields the best evaluation parameters may be selected for use.

According to some examples, the method includes applying the transformation function with the identified constants and the calibration line constants as calibration parameters (or a set of calibration parameters) for the laboratory analytical instrument at block 1012. For instance, the signal output of the detector of the laboratory analytical instrument may be transformed using the transformation function, as shown above in Equation 3.

In some embodiments, the calibration parameters may be specific to the analyte being tested. The process may be repeated for different analytes so that different calibration parameters may be determined for different analytes.

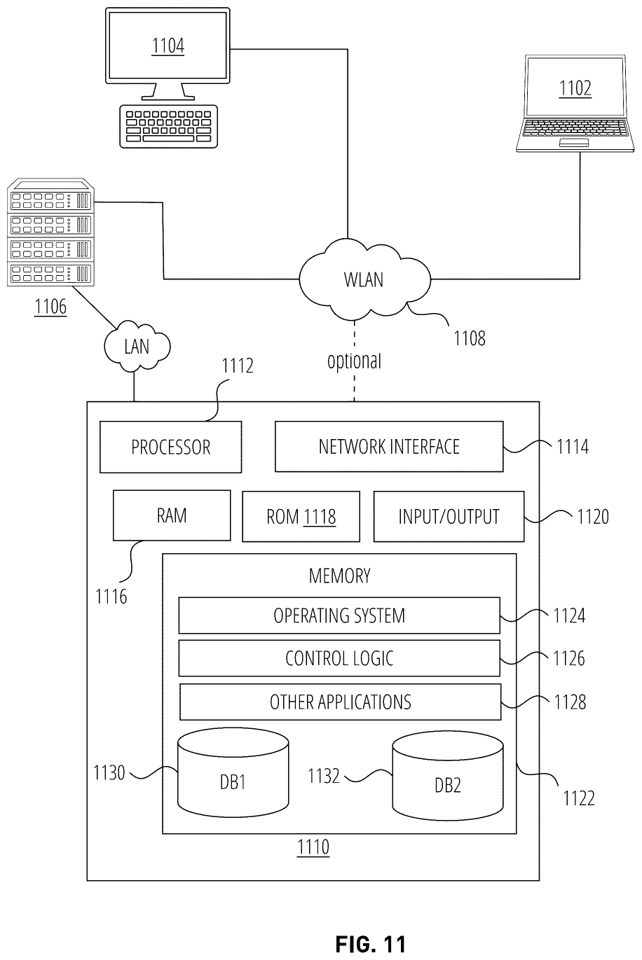

FIG. 11 illustrates one example of a system architecture and data processing device that may be used to implement one or more illustrative aspects described herein in a standalone and/or networked environment. Various network nodes, such as the data server 1110, web server 1106, computer 1104, and laptop 1102 may be interconnected via a wide area network 1108 (WAN), such as the internet. Other networks may also or alternatively be used, including private intranets, corporate networks, LANs, metropolitan area networks (MANs) wireless networks, personal networks (PANs), and the like. Network 1108 is for illustration purposes and may be replaced with fewer or additional computer networks. A local area network (LAN) may have one or more of any known LAN topology and may use one or more of a variety of different protocols, such as ethernet. Devices data server 1110, web server 1106, computer 1104, laptop 1102 and other devices (not shown) may be connected to one or more of the networks via twisted pair wires, coaxial cable, fiber optics, radio waves or other communication media.

Computer software, hardware, and networks may be utilized in a variety of different system environments, including standalone, networked, remote-access (aka, remote desktop), virtualized, and/or cloud-based environments, among others.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 1110, web server 1106, and client computer 1104, laptop 1102. Data server 1110 provides overall access, control and administration of databases and control software for performing one or more illustrative aspects described herein. Data server data server 1110 may be connected to web server 1106 through which users interact with and obtain data as requested. Alternatively, data server 1110 may act as a web server itself and be directly connected to the internet. Data server 1110 may be connected to web server 1106 through the network 1108 (e.g., the internet), via direct or indirect connection, or via some other network. Users may interact with the data server 1110 using remote computer 1104, laptop 1102, e.g., using a web browser to connect to the data server 1110 via one or more externally exposed web sites hosted by web server 1106. Client computer 1104, laptop 1102 may be used in concert with data server 1110 to access data stored therein, or may be used for other purposes. For example, from client computer 1104, a user may access web server 1106 using an internet browser, as is known in the art, or by executing a software application that communicates with web server 1106 and/or data server 1110 over a computer network (such as the internet).

Servers and applications may be combined on the same physical machines, and retain separate virtual or logical addresses, or may reside on separate physical machines. FIG. 11 illustrates just one example of a network architecture that may be used, and those of skill in the art will appreciate that the specific network architecture and data processing devices used may vary, and are secondary to the functionality that they provide, as further described herein. For example, services provided by web server 1106 and data server 1110 may be combined on a single server.

Each component data server 1110, web server 1106, computer 1104, laptop 1102 may be any type of known computer, server, or data processing device. Data server 1110, e.g., may include a processor 1112 controlling overall operation of the data server 1110. Data server 1110 may further include RAM 1116, ROM 1118, network interface 1114, input/output interfaces 1120 (e.g., keyboard, mouse, display, printer, etc.), and memory 1122. Input/output interfaces 1120 may include a variety of interface units and drives for reading, writing, displaying, and/or printing data or files. Memory 1122 may further store operating system software 1124 for controlling overall operation of the data server 1110, control logic 1126 for instructing data server 1110 to perform aspects described herein, and other application software 1128 providing secondary, support, and/or other functionality which may or may not be used in conjunction with aspects described herein. The control logic may also be referred to herein as the data server software control logic 1126. Functionality of the data server software may refer to operations or decisions made automatically based on rules coded into the control logic, made manually by a user providing input into the system, and/or a combination of automatic processing based on user input (e.g., queries, data updates, etc.).

Memory 1122 may also store data used in performance of one or more aspects described herein, including a first database 1132 and a second database 1130. In some embodiments, the first database may include the second database (e.g., as a separate table, report, etc.). That is, the information can be stored in a single database, or separated into different logical, virtual, or physical databases, depending on system design. Web server 1106, computer 1104, laptop 1102 may have similar or different architecture as described with respect to data server 1110. Those of skill in the art will appreciate that the functionality of data server 1110 (or web server 1106, computer 1104, laptop 1102) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A charged aerosol detector (CAD) apparatus configured to process an analyte stream, comprising:
an ion trap configured to remove charged particles from an analysis stream by applying a voltage of 100 Volts (V) or more; and
a detector configured to register analyte from the analyte stream after it passes through the ion trap to generate a detector response.

2. The apparatus for use of claim 1, wherein the voltage is in a range of 200-650 V.

3. The apparatus for use of claim 1, wherein the voltage is adjustable via a user interface, the user interface displaying at least a first default selection that is less than 100 V and a second selection that is 100 V or more.

4. The apparatus for use of claim 3, wherein the user interface displays multiple different preconfigured options that are 100V or more.

5. The apparatus for use of claim 1, wherein the CAD is configured to:
apply the voltage of 100 V or more with the ion trap;
determine that an amount of analyte lost to the ion trap exceeds a predetermined threshold value; and
reduce the voltage applied by the ion trap.

6. The apparatus for use of claim 1, wherein the CAD processes particles having diameters greater than 9 nm and 9 nm or less, and the voltage is selected to drive proportionally more particles having a diameter of 9 nm or less into a wall of the ion trap to remove them from the analyte stream.

7. The apparatus for use of claim 1, further comprising a processor programmed with instructions to:
analyze the detector response to produce an analyte-response curve; and
apply a log-log linear fit to the analyte-response curve to produce a fit curve that corresponds to the analyte-response curve.

8. A method of generating a detector response in a charged aerosol detector (CAD) apparatus configured to process an analyte stream, the method comprising:
applying a voltage of 100 Volts (V) or more at an ion trap configured to remove charged particles from an analysis stream; and
registering analyte from the analyte stream on a detector after it passes through the ion trap to generate a detector response.

9. The method of claim 8, wherein the voltage is in a range of 200-650 V.

10. The method of claim 8, further comprising displaying a user interface configured to allow a user to adjust the voltage, the user interface displaying at least a first default selection that is less than 100 V and a second selection that is 100 V or more.

11. The method of claim 10, wherein the user interface displays multiple different preconfigured options that are 100V or more.

12. The method of claim 8, further comprising:
applying the voltage of 100 V or more with the ion trap;
determining that an amount of analyte lost to the ion trap exceeds a predetermined threshold value; and
reducing the voltage applied by the ion trap.

13. The method of claim 8, wherein the CAD processes particles having diameters greater than 9 nm and 9 nm or less, and the voltage is selected to drive proportionally more particles having a diameter of 9 nm or less into a wall of the ion trap to remove them from the analyte stream.

14. The method of claim 8, further comprising:
analyzing the detector response to produce an analyte-response curve; and
applying a log-log linear fit to the analyte-response curve to produce a fit curve that corresponds to the analyte-response curve.

15. A non-transitory computer-readable storage medium storing instructions that, when executed by one or more processors, configure the processors to generate a detector response in a charged aerosol detector (CAD) apparatus configured to process an analyte stream, the instructions comprising instructions for:
applying a voltage of 100 Volts (V) or more at an ion trap configured to remove charged particles from an analysis stream; and
registering analyte from the analyte stream on a detector after it passes through the ion trap to generate a detector response.

16. The medium of claim 15, wherein the voltage is in a range of 200-650 V.

17. The medium of claim 15, the instructions further comprising instructions for displaying a user interface configured to allow a user to adjust the voltage, the user interface displaying at least a first default selection that is less than 100 V and a second selection that is 100 V or more.

18. The medium of claim 15, the instructions further comprising instructions for:
applying the voltage of 100 V or more with the ion trap;
determining that an amount of analyte lost to the ion trap exceeds a predetermined threshold value; and
reducing the voltage applied by the ion trap.

19. The medium of claim 15, wherein the CAD processes particles having diameters greater than 9 nm and 9 nm or less, and the voltage is selected to drive proportionally more particles having a diameter of 9 nm or less into a wall of the ion trap to remove them from the analyte stream.

20. The medium of claim 15, the instructions further comprising instructions for:
analyzing the detector response to produce an analyte-response curve; and
applying a log-log linear fit to the analyte-response curve to produce a fit curve that corresponds to the analyte-response curve.

21. A method comprising:
operating a laboratory analytical instrument on an analyte at a plurality of different concentrations to generate response data comprising a plurality of data points;
assigning a first non-linear relationship to the response data;
transforming the plurality of data points in the response data into a set of calculated response data points by applying a transformation function that is an inverse of the assigned non-linear relationship;
assigning a second linear relationship to the calculated response data points;
identifying constants for the transformation function that cause the second linear relationship to best approximate the calculated response data points to obtain a linear relationship between peak response parameters and the plurality of different concentrations; and
applying the transformation function with the identified constants and the second linear calibration parameters as calibration parameters for the laboratory analytical instrument.

22-40. (canceled)

41. The method of claim 21, wherein:
the laboratory analytical instrument is a charged aerosol detector (CAD) comprising an ion trap configured to remove charged particles from an analysis stream containing the analyte by applying a voltage of 100 Volts (V) or more.
